(19) United States
(12) Patent Application Publication
(10) Pub. No.: US 2004/0126112 A1
(43) Pub. Date: Jul. 1, 2004

(54) Method for optically copying packet

(76) Inventors: Byoung Whi Kim, Daejeon (KR); Bong Kyu Kim, Daejeon-city (KR); Hyeong Ho Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/735,457

(22) Filed: Dec. 11, 2003

(30) Foreign Application Priority Data
Dec. 12, 2002 (KR) 2002-79266
Oct. 2, 2003 (KR) 2003-68619

(51) Int. Cl. H04J 14/00

(52) U.S. Cl. 398/51

(57) ABSTRACT

A method for optically copying a packet is provided. The method performs a broadcasting operation of a packet in a subscriber access network based on a wavelength division multiplexing using an optical broadcast module, which is disposed independently from an optical label exchange (OLX) switch. The method includes: (a) dividing the packet, which is received from an optical group exchange (OGX) controlled by the OLX switch, into a header and a payload; (b) applying the payload to an i-th port of the OLX switch; (c) leading the payload to the optical broadcast module by controlling the OLX switch so that when the header represents a label for broadcasting, a corresponding broadcasting port of the OLX switch is set as an output port of the OLX switch; and (d) reframing the header and the payload and transmitting the reframed header and the payload to a backbone network using the optical broadcast module.

### BACKGROUND OF THE INVENTION

This application claims the priority of Korean Patent Application Nos. 2002-79266 filed on Dec. 12, 2002 and 2003-68619 filed on Oct. 2, 2003, in the Korean Intellectual Property Office, the disclosure of which is incorporated herein in its entirety by reference.

1. Field of the Invention

The present invention relates to a method for optically copying a packet, and more particularly, to a method for optically multicasting or broadcasting a packet using switching nodes which control subscriber regional networks (SR) and a metro-core ring (MR) that connects the SRs, in a subscriber access network based on wavelength division multiplexing (WDM).

2. Description of the Related Art

At present, union of communication and broadcasting that combines and provides data transmission service and cable broadcasting service is rapidly proceeded, broadcasting service using a switching/routing system based on conventional packet processing method has a problem in performing the switching/routing functions.

A packet in an internet group management protocol (IGMP), which is the commercial internet multicasting protocol presently used, is encapsulated and transmitted in an information unit in an internet protocol (IP) packet. Therefore, grouping algorithm and transmission algorithm in IGMP group are based on routing information of layer 3, and a router is applied by the multi-casting service. That is, the core of the grouping information in the multi-casting is a user terminal and the router. However, virtual local area network (VLAN) method suggested by 802.1p/q has an object that the packet is transmitted in order of multi-casting and priority in layer 2.

The above method aims to reduce an amount of multi-casting background traffics by limiting a crash area of a frame by granting VLAN identifier (VID) to each of the ports, that is, by transmitting the frame only for the port included in the same group on the VLAN.

A port-based VLAN method of two-layer is operated based on the two-layer information, thus can be applied effectively to a wavelength division multiplexing-active optical network (WDM-AON) shown in FIG. 1. However, above-described technologies are sub-functions of Ethernet switch or routing switch and control function, and become the loads in the switching/routing system.

### SUMMARY OF THE INVENTION

The present invention provides a method for optically copying a packet satisfying following conditions in broadcasting or multicasting the packet optically.

1. A general switching module can be used by attaching/separating a module for optical packet copying to/from a switching system, and the packet copying operation is independently performed in the optical copying module not to affect the traffic processing capability of the system.

2. The optical copying method is used not to increase a complexity of the switch controlling function, thus improving reliability and economic efficiency of the system.

According to an aspect of the present invention, there is provided a method for optically copying a packet performing a broadcasting operation of a packet in a subscriber access network based on a wavelength division multiplexing (WDM) using an optical broadcast module disposed independently from an optical label exchange (OLX) switch, and the method includes (a) dividing the packet, which is input from an optical group exchange (OGX) controlled by the OLX switch, into a header and a payload, (b) applying the payload to an i-th port of the OLX switch, (c) leading the payload to the optical broadcast module by controlling the OLX switch so that when the header represents a label for broadcasting, a corresponding broadcasting port of the OLX switch is set as an output port of the OLX switch, and (d) reframing the header and the payload and transmitting the reframed header and the payload to a backbone network using the optical broadcast module.

According to another aspect of the present invention, there is provided a method for optically copying a packet performing a multicasting operation of a packet in a subscriber access network based on a WDM using an optical broadcast module disposed independently from an optical label exchange switch, and the method includes (a) dividing the packet, which is received from an OGX controlled by the OLX switch, into a header and a payload, (b) applying the payload to an i-th port of the OLX switch, (c) leading the payload to the optical multicast module by controlling the OLX switch so that when the header represents a label for multicasting, a corresponding multicasting port of the OLX switch is set as an output port of the OLX switch, and (d) reframing the header and the payload and transmitting the reframed header and the payload to a backbone network using the optical multicast module.

### BRIEF DESCRIPTION OF THE DRAWINGS

The above and other features and advantages of the present invention will become more apparent by describing in detail exemplary embodiments thereof with reference to the attached drawings in which:

FIG. 1a is a block diagram of a wavelength division multiplexing-active optical network (WDM-AON) which is applied by the present invention;

FIG. 1b is a flow chart of a method for optically broadcasting a packet;

FIG. 2 is a view of an optical label exchange (OLX) controlling a metro-core ring (MR) of the WDM-AON and an optical broadcasting module for a packet connected to OLX and applied by the present invention;

FIG. 3 is a view of a transformation of an optical signal generated in the optical broadcasting module shown in FIG. 2;

FIG. 4a is a view of an OLX controlling an MR of the WDM-AON and an optical multicasting module for a packet connected to OLX and applied by the present invention; and

FIG. 4b is a flow chart of a method for multicasting a packet optically; and

FIG. 5 is a view of transformation of an optical signal generated in the module for optically multicasting the packet shown in FIG. 4a.

### DETAILED DESCRIPTION OF THE INVENTION

Hereinafter, embodiments of the present invention will be described with reference to accompanying figures in detail. For same elements, same reference numerals are used, and an element of other figures can be referred if needed.

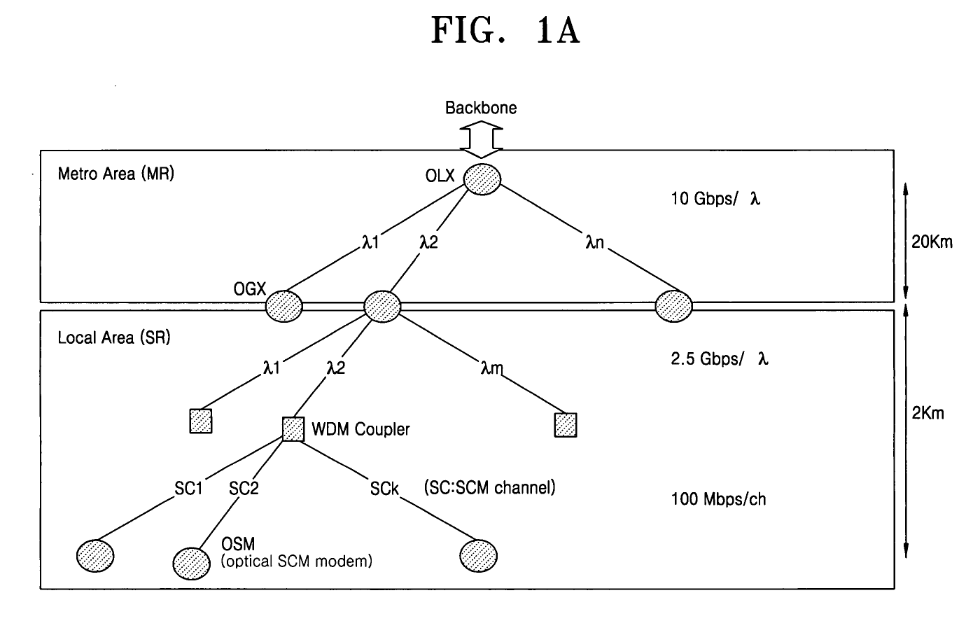

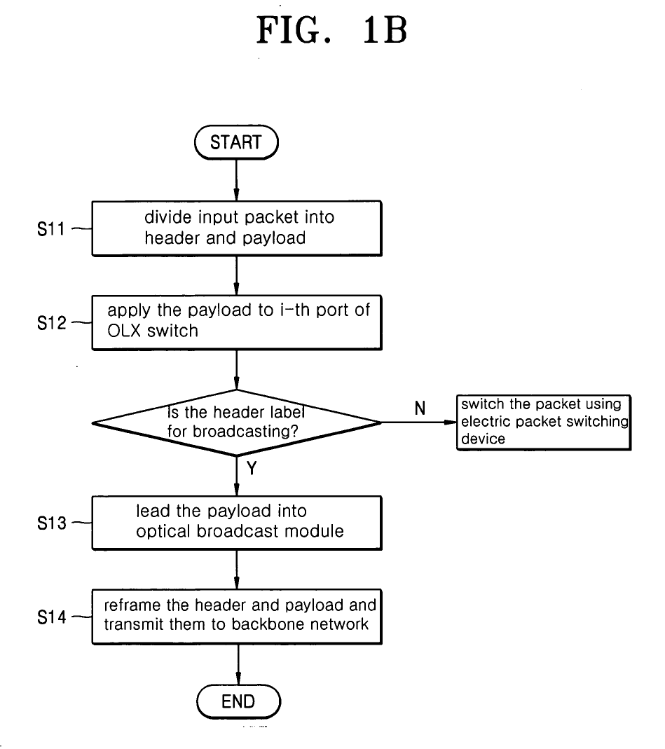

FIG. 1a is a block diagram of a wavelength division multiplexing-active optical network (WDM-AON) to which the present invention is applied, and FIG. 1b is a flow chart of a method for optically broadcasting a packet.

The objected network sets a communication path using WDM technology and a subcarrier multiplexing (SCM) technology. A subscriber is allocated an SCM channel through an optical modem (OSM) of SCM type to connect the network, and a plurality of OSMs share optical wavelengths (λ1, λ2, . . . , λm) through a WDM coupler. A subscriber regional network (SR) including the subscriber optical modems forms a local area network and is controlled by an OGX(optical group exchange).

The OGX provides the optical modem (OSM) with the communication path using the WDM, WDM coupler, and SCM. A plurality of local area networks are connected to each other through the OGXs to form a metro-core ring (MR). The MR is controlled by an optical label exchange (OLX), and WDM provides the MR with the communication path. FIG. 1a shows a typical network for convenience' sake. The SR has a reach of 2 km, and MR is formed within 20 km range.

A sever for broadcasting or for video on demand (VoD) is connected to the OLX to provide subscribers in a metro area with related service. Here, the OLX should performs functions related to broadcasting or multicasting of corresponding packet, as well as the switching operation of general data packets. Also, OGXs included in the OLX should perform the functions related to the broadcasting or multicasting of the packets according to the information received from OLX, in order to provide the subscribers with related services. Therefore, the optical copying method can be commonly applied to the OGX and OLX although these have different positions and functions in the network from each other.

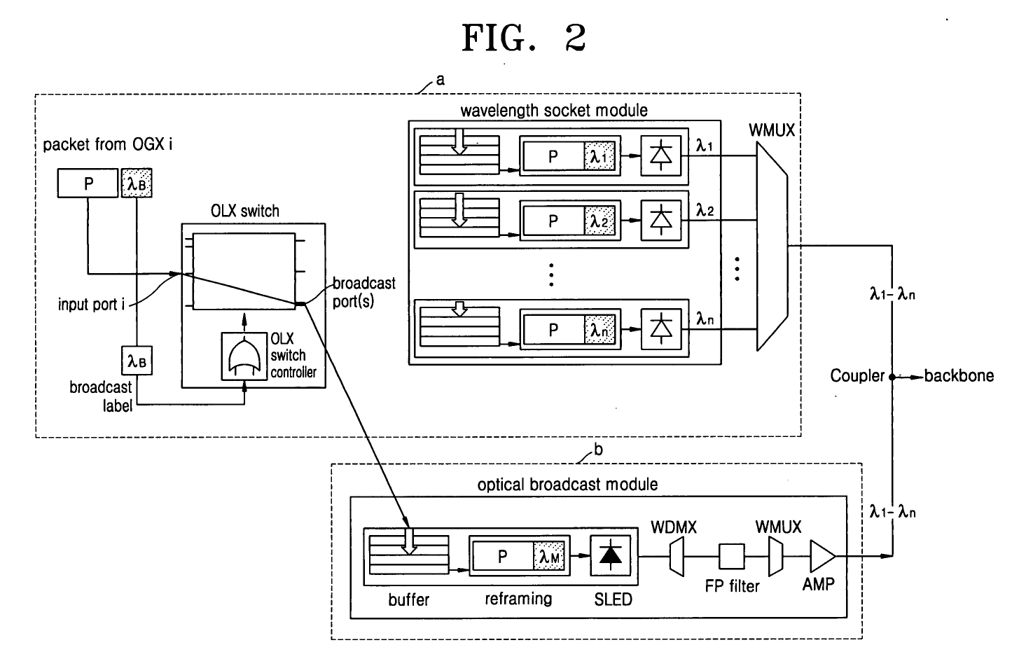

In FIG. 2, part a is a block diagram of the OLX shown in FIG. 1a, and part b is a block diagram of an optical broadcast module connected to the OLX and applied by the present invention. As shown in FIG. 2, part b is disposed independently from part a.

An input packet inputted from OGX i, or broadcasting or VoD server (hereinafter, referred to as server) is divided into a header (λB) and a payload (P) (S11). The payload is inputted into i-th port (input port i) of OLX switch (S12), and the header is analyzed by an OLX switch controller. If the header means a broadcast label (B of λB refers to broadcast), an OLX switch output port is set to corresponding broadcast port so that the packet is switched to the broadcast port.

The packet output from the broadcast port is input into the optical broadcast module (b) (S13). The packet input into the optical broadcast module (b) is stored in a buffer, and output according to first-in-first-out (FIFO) or predetermined packet transmission priority. In addition, information can be added/subtracted to/from the packet in a reframing operation.

The packet is changed to light by a super luminescence light emission diode (SLED) having a broad bandwidth including all bandwidths of WDM optical wavelengths. The optical signal of the SLED having wide spectrum range passes through a WDM demultiplexer (WDMX) so that the wavelength (spectrum) set by ITU-T standard.

Spectral widths of the selected wavelengths are adjusted by a Fabry-Perot (FP) filter, if the spectral widths should be narrowed so that the transmission is not affected by the distance. The optical signals, the wavelengths of which are selected and spectral widths of which are adjusted, carry same packet information as each other, and multiplexed by a WDM multiplexer (WMUX) to be sent to a backbone network and amplified by an amplifier (AMP) to be transmitted.

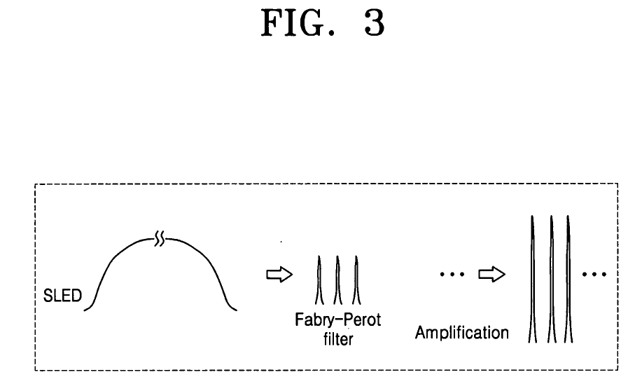

FIG. 3 is a view of transformation of the signal generated since the optical signal passes through the SLED, WDM DMX, FP filter, and AMP in the optical broadcast module.

The SLED output signal modulated by an electric packet has wide frequency range, and when the signal passes through the WDM DMX, wavelengths having predetermined frequencies are selected. The frequency spectral widths of the selected wavelengths are decided by a pass-band bandwidth in the WDM DMX. In a case where the spectral width should be narrowed for ensuring sufficient transmission distance, the spectral width of the optical signal output from the WDM DMX is adjusted by the FP filter. Here, the adjusted spectral width should be discriminated with the frequency spectral width of the optical packet for the data. For example, when the frequency spectral width of the optical packet for the data is a few MHz, the spectral width of the broadcast wavelength is adjusted hundreds of MHz within the transmission distance range.

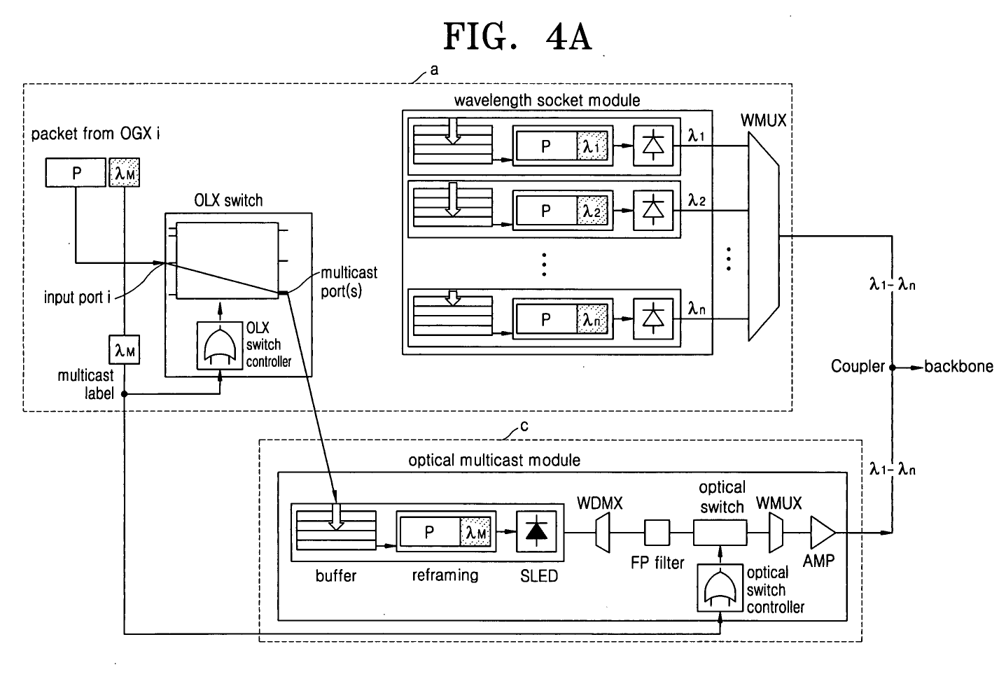

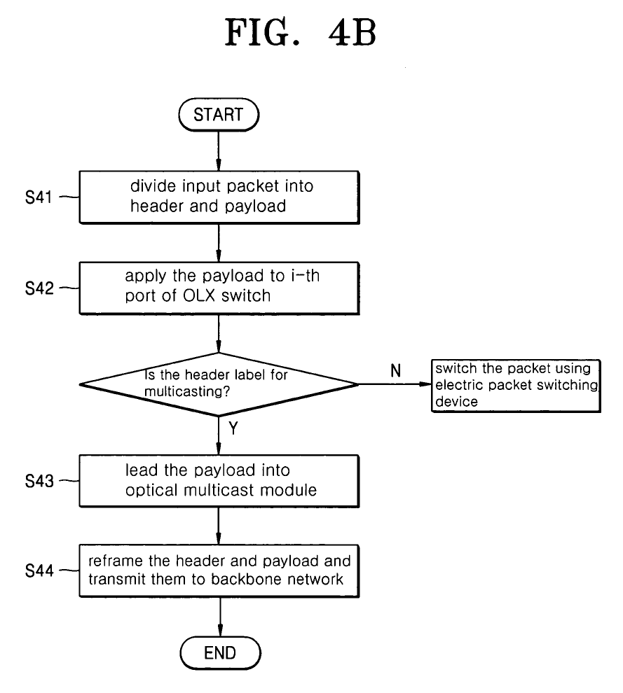

FIG. 4a is a view of the OLX controlling the MR of WDM-AON and an optical multicast module connected to the OLX, and FIG. 4b is a flow chart of the optical mutlicast method of the packet.

Processes until the packet is input into the optical multicast module (c) are same as those of FIGS. 1a through 2, and the packet is also modulated by the SLED and passes through the WDM DMX in the optical multicast processes. However, in case of the multicast, some of the wavelengths among the wavelengths (spectrum) set by ITU-T should be copied, thus there is no need to select the wavelengths. According to the present invention, the copied wavelengths are passed using an optical switch, and remaining wavelengths are blocked.

That is, the optical switch controller recognizes that the multicast-objected packet is input with reference to the header (λM, M refers to multicast), then the multicast-objected wavelengths are passed and remaining wavelengths are blocked. The optical wavelengths passing through the optical switch is multiplexed in the WDM MUX so as to be transmitted to the network as in the broadcasting operation, and amplified by the amplifier so as to be transmitted. (S41˜S44).

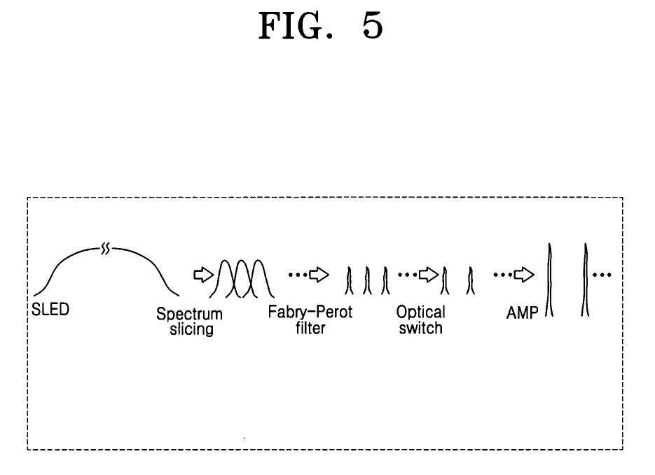

FIG. 5 is a view of transformation of the signal as the optical signal passes through the SLED, WDM DMX, FP filter, and AMP in the optical multicast module.

Processes of passing through the SLED, the WDM DMX, and the FP filter are same as those of FIG. 3, and the wavelengths are selected by adding the optical switch.

The method according to the present invention can be realized as the codes readable by a computer in a recording medium readable by the computer. The computer-readable recording medium includes all kinds of recording media in which data read by the computer are stored. For example, the recording media such as a read only memory (ROM), a random access memory (RAM), CD-ROM, a magnetic tape, a floppy disk, and an optical data storing device can be used, also can be realized as a carrier wave (for example, transmission through internet) form. Also, the computer-readable recording medium is distributed in a computer system connected through the network, the codes read by the computer can be stored and performed as distributed in the computer system.

According to present invention, the packet can be broadcasted or multicasted optically out of the switch using the advantages of WDM technology, thus adding no additional load to the conventional switching function, and the traffic processing capacity of the switching system is not affected.

Also, the optical copy module is realized independently from the OLX switch, and can be attached/separated to/from the switch. Therefore, the general switching system can be used and the complexity of switch controlling function does not increase, thus improving the reliability and the economic efficiency of the system.

Especially, according to the present invention, the server system providing packet copying service such as the cable television or the VoD can be intensified in cost-economical way.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for optically copying a packet, in which a packet in a subscriber access network based on a wavelength division multiplexing is broadcasted using an optical broadcast module disposed independently of an optical label exchange switch, the method comprising:
(a) dividing the packet, which is received from an optical group exchange controlled by the optical label exchange switch, into a header and a payload;
(b) applying the payload to an i-th port of the optical label exchange switch;
(c) leading the payload to the optical broadcast module by controlling the optical label exchange switch so that when the header represents a label for broadcasting, a corresponding broadcasting port of the optical label exchange switch is set as an output port of the optical label exchange switch; and
(d) reframing the header and the payload and transmitting the reframed header and the payload to a backbone network using the optical broadcast module.

2. The method of claim 1, wherein step (d) comprises:
(d1) storing the payload in a buffer;
(d2) outputting the payload and the header from the buffer according to transmission priority and generating a reframing packet;
(d3) changing the reframing packet into optical signals having various wavelengths;
(d4) demultiplexing the optical signals having various wavelengths so as to select only the optical signals having admitted wavelengths;
(d5) filtering the demultiplxed optical signals so as to adjust the spectral width of the optical signals to ensure a sufficient transmission distance; and
(d6) multiplexing and amplifying the filtered optical signals so as to transmit the signals to the backbone network.

3. A method for optically copying a packet, in which a packet in a subscriber access network based on a wavelength division multiplexing is multicasted using an optical broadcast module disposed independently of an optical label exchange switch, the method comprising:
(a) dividing the packet, which is received from an optical group exchange controlled by the optical label exchange switch, into a header and a payload;
(b) applying the payload to an i-th port of the optical label exchange switch;
(c) leading the payload to the optical multicast module by controlling the optical label exchange switch so that when the header represents a label for multicasting, a corresponding multicasting port of the optical label exchange switch is set as an output port of the optical label exchange switch; and
(d) reframing the header and the payload and transmitting the reframed header and the payload to a backbone network using the optical multicast module.

4. The method of claim 3, wherein step (d) comprises:
(d1) storing the payload in a buffer;
(d2) outputting the payload and the header from the buffer according to transmission priority and generating a reframing packet;
(d3) changing the reframing packet into optical signals having various wavelengths;
(d4) demultiplexing the optical signals having various wavelengths so as to select only the optical signals having admitted wavelengths;
(d5) filtering the demultiplxed optical signals so as to adjust the spectral width of the optical signals to ensure a sufficient transmission distance;
(d6) passing the multicast-objected wavelength in the filtered optical signals and blocking remaining optical signals; and
(d7) multiplexing and amplifying the multicast-objected signal so as to transmit the signal to the backbone network.
